(19) United States
(12) Patent Application Publication
(10) Pub. No.: US 2025/0247379 A1
(43) Pub. Date: Jul. 31, 2025

(54) Self-Healing Connections Between Storage Systems And Worker Nodes

(71) Applicant: NetApp, Inc., San Jose, CA (US)

(72) Inventors: Rohit Arora, Cary, NC (US); Ravi Kumar Midatana, Bangalore (IN); Vinay Kumar H S, Bangalore (IN); Puneeth Andanappa, Bangalore (IN); Gaurav Mukul Bhatnagar, Bangalore (IN); Shubham Ravindra Phadnis, Bangalore (IN)

(73) Assignee: NetApp, Inc., San Jose, CA (US)

(21) Appl. No.: 18/782,301

(22) Filed: Jul. 24, 2024

Related U.S. Application Data
(60) Provisional application No. 63/626,763, filed on Jan. 30, 2024.

(51) Int. Cl. H04L 9/40

(52) U.S. Cl. CPC H04L 63/08

(57) ABSTRACT

The technology disclosed herein enables worker nodes to reestablish connections when the connection protocols fail to successfully reconnect on their own. In a particular example, a method includes establishing a plurality of TCP-based connections (e.g., iSCSI and/or NVMe) between a plurality of worker nodes and a storage system and determining status of the plurality of TCP-based connections. When the status indicates a first connection of the plurality of TCP-based connections has failed, the method includes determining credentials used to establish the first connection are invalid. In response to determining the credentials are invalid, the method includes requesting new credentials from a controller node and reestablishing the first connection using the new credentials.

### RELATED APPLICATIONS

This application is related to and claims priority to U.S. Provisional Patent Application 63/626,763, titled “SELF-HEALING CONNECTIONS BETWEEN STORAGE SYSTEMS AND WORKER NODES,” filed Jan. 30, 2024, and which is hereby incorporated by reference in its entirety.

### TECHNICAL FIELD

Failure handling for iSCSI and NVMe data connections between computing systems.

### BACKGROUND

CHAP (Challenge-Handshake Authentication Protocol) authentication is a method of securing Kubernetes clusters with certificate-based authentication. It allows pods to communicate with each other and with the API server using digital certificates that are signed by a trusted authority. Chap authentication can enhance the security and privacy of Kubernetes clusters by preventing unauthorized access and tampering. Chap authentication works by using a client certificate and a private key for each pod. The client certificate contains the identity information of the pod, such as its name, namespace, and role. The private key is used to sign and verify the client certificate. When a node wants to access another node or the API server, it presents its client certificate to the server, which verifies its signature and validity. If the verification succeeds, the server grants access to the node. If not, the server denies access and returns an error. When a node lacks a connection, pods executing thereon likewise cannot communicate with pods/processes executing on other nodes.

Dynamic storage provisioners, such as NetApp Trident, enable the efficient use of storage for Kubernetes environments by dynamically provisioning storage volumes for use by pods in Kubernetes clusters. In a Kubernetes cluster, a controller node is responsible for managing the state of the cluster. The controller node runs the Kubernetes control plane components, such as the API server, etcd, kube-scheduler, a controller for the dynamic storage provisioner (e.g., a Trident CSI (Computer System Interface) controller), and kubecontroller-manager. The API server is the central management point for the cluster, while etcd is a distributed key-value store that stores the cluster's configuration data. The kube-scheduler schedules workloads to run on the worker nodes, and the kube-controller-manager manages the state of the cluster's resources. A worker node is responsible for running the workloads in the cluster. It runs the Kubernetes node components, such as the kubelet and kube-proxy, and a node server for the dynamic storage provisioner (e.g., a Trident CSI server). The kubelet is responsible for managing the state of the pods running on the node, while kube-proxy is responsible for managing the network connectivity between the pods and the rest of the cluster. The node server ensures the worker nodes in the Kubernetes cluster are able to mount the volumes provisioned for pods.

If iSCSI (Internet Small Computer Systems Interface) is a storage networking protocol used to mount the volumes, CHAP may be used to authenticate the worker nodes for access to the storage system containing the volumes. The controller node is responsible for updating credentials for the worker nodes over their respective iSCSI connections. If something goes wrong with a worker node's iSCSI connection, updated CHAP credentials may not be received by the worker node. The node will not be able to connect to the storage system. When the worker node cannot connect to the storage system, any pods executing on the node cannot access volumes on the storage system.

### SUMMARY

The technology disclosed herein enables worker nodes to reestablish connections when the connection protocols fail to successfully reconnect on their own. In a particular example, a method includes establishing a plurality of TCP-based connections between a plurality of worker nodes and a storage system to enable the plurality of worker nodes to access storage volumes in the storage system. When a status of a first connection of the plurality of TCP-based connections indicates the first connection failed between a worker node of the plurality of worker nodes and the storage system, the method includes waiting an amount of time. Upon the amount of time elapsing, the method includes determining the first connection has not recovered. In response to determining the first connection has not recovered, the method includes determining credentials used by the worker node to establish the first connection are currently invalid. In response to determining the credentials are currently invalid, the method includes requesting new credentials from a controller node and reestablishing the first connection using the new credentials

In another example, a method includes capturing state information about iSCSI sessions of a worker node. The state information includes a desired state of the iSCSI sessions and an actual state of the iSCSI sessions. The method also includes identifying differences between the desired state and the actual state. The differences indicate at least one iSCSI session is no longer working as indicated by the desired state. The method further includes fixing the at least one iSCSI session to match a state of the at least one iSCSI session indicated by the desired state.

In a further example, a method includes creating a map of current NVMe sessions between the worker nodes and the storage system and creating a map of published NVMe session between the worker nodes and the storage system. The method also includes determining an NVMe session specified in the map of published NVMe sessions is not specified in the map of current NVMe sessions and establishing the NVMe session in accordance with specifications from the map of published NVMe sessions.

In an additional example, a system includes a computing cluster comprising a plurality of computing nodes, a storage system storing a plurality of storage volumes, a worker node of the plurality of computing nodes, and a controller node of the plurality of computing nodes. The worker node is configured to use the authentication credentials to establish a connection with the storage system using a storage networking protocol to access a volume of the plurality of storage volumes, detect the connection has failed, and wait for the storage networking protocol to attempt reestablishment of the connection using the authentication credentials. After the storage networking protocol stops attempting the reestablishment, request new authentication credentials from the controller node and reestablish the connection with the storage system using the new authentication credentials. The controller node is configured to receive the new authentication credentials when the storage system receives the new authentication credentials and transmit the new authentication credentials to the worker node when the worker node requests the new authentication credentials.

### BRIEF DESCRIPTION OF THE DRAWINGS

FIG. 1 illustrates an implementation for reestablishing connections between worker nodes and a storage system.

FIG. 2 illustrates an operation to reestablish connections between worker nodes and a storage system.

FIG. 3 illustrates an operational scenario for reestablishing connections between worker nodes and a storage system.

FIG. 4 illustrates an operation to reestablish connections between worker nodes and a storage system.

FIG. 5 illustrates an implementation for reestablishing connections between worker nodes and a storage system.

FIG. 6 illustrates an operation to reestablish connections between worker nodes and a storage system.

FIG. 7 illustrates an operation to reestablish connections between worker nodes and a storage system.

FIG. 8 illustrates an operation to reestablish connections between worker nodes and a storage system.

FIG. 9 illustrates an operation to reestablish connections between worker nodes and a storage system.

FIG. 10 illustrates a computing system for reestablishing connections between worker nodes and a storage system.

### DETAILED DESCRIPTION

A typical dynamic storage provisioner does a good job of automatically establishing iSCSI sessions between pods on a worker node and storage volumes in a storage system. The establishment process is commonly referred to as staging the pods. When something happens causing an iSCSI session to go down (e.g., a network connectivity issue), manual intervention is typically necessary to trigger the reestablishment of the iSCSI connection(s) between the storage system and the affected pods. For instance, the worker node may be restarted, or the storage volume may be moved to trigger a reconnection. In the meantime, all reads/writes by the affected pods to the storage system will fail preventing the pods from performing their assigned tasks. If the authentication credentials used to establish the connection are no longer valid, the connection cannot be reestablished using the typical process defined by iSCSI.

In the examples below, the dynamic storage provisioner keeps a record of the desired states for the iSCSI connections of the pods. For instance, the record may identify respective iSCSI connections and indicate whether the connection is active, failed, establishing, failing, or some other potential state. If, in an example, a pod's actual state indicates the pod has no iSCSI connections (or, e.g., has an iSCSI connection in a failed state) when the records of the dynamic storage provisioner indicate the pod should have an iSCSI connection in an active state, then the dynamic storage provisioner performs steps necessary to reestablish the iSCSI connection into an active state. When originally establishing the iSCSI connection, the controller of the dynamic storage provisioner communicates with the storage system to retrieve information necessary to establish the connection. The information may include a volume identifier, a connection port, an iSCSI qualified name, etc. If CHAP is being used, the controller also retrieves CHAP credentials as part of the information. CHAP credentials typically include a username and what CHAP refers to as a secret. A CHAP secret is typically a string of characters, often generated randomly or chosen by a user. A client in a CHAP authentication must have CHAP credentials (i.e., username and secret) matching the server in a CHAP authentication for the CHAP authentication to be successful.

When reestablishing the iSCSI connection, the controller of the dynamic storage provisioner may first direct the node server of the dynamic storage provisioner at the worker node to use the originally retrieved information. However, during the time the connection was down, the CHAP credentials may have rotated by a user at the storage system and no connection existed over which the worker node could be updated by the storage system. The controller will have also been updated with the new CHAP credentials and, therefore, provides the new credentials to the node server at the worker node to reestablish the connection.

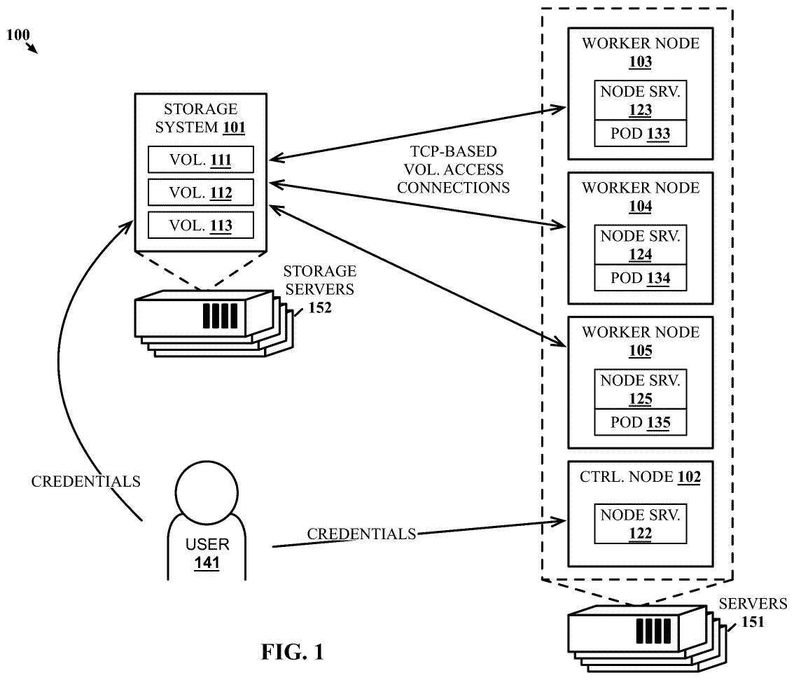

FIG. 1 illustrates implementation 100 for reestablishing connections between worker nodes and a storage system. Implementation 100 includes storage system 101 implemented by one or more storage servers 152 and nodes 102-105 executing on one or more computing servers 151. Worker nodes 103-105 host pods 133-135. A pod is the smallest deployable unit of computing in a Kubernetes cluster. A pod is a group of one or more containers that share the same host system (e.g., one of computing servers 151). Pods 133-135 may be the same (e.g., including the same containerized processes) or different. Storage system 101 is a networked storage system storing data thereon in storage volumes 111-113. While not shown, storage system 101 and worker nodes 103-105 communicate over one or more communication networks including communication links, network systems, network devices, or other type of data communication components.

In operation, node servers 123-125 are node servers of a dynamic storage provisioner, such as Trident, and handle the establishment of TCP-based connections between respective ones of worker nodes 103-105 and storage system 101. Pods 133-135 access one or more of storage volumes 111-113 over the established connections. Pods 133-135 may read data from, write data to, or perform some other access function—including combinations thereof—on one or more of storage volumes 111-113. The connections may use any protocol for volume access over TCP (Transmission Control Protocol), sometimes referred to as a storage networking protocol. Two example protocols are iSCSI and NVMe (Nonvolatile Memory Express), although, other protocols may be used instead. While a protocol may include a procedure for reestablishing a failed connection, the protocol may still be unable to reestablish the connection without manual intervention. node servers 123-125 and controller 122 work of the dynamic storage provisioner together in the examples below to reestablish connections that were unable to be reestablished without Trident's intervention.

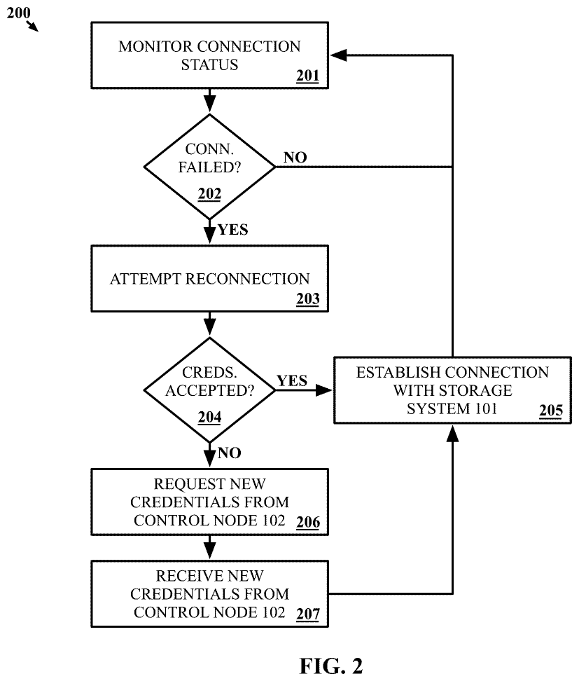

FIG. 2 illustrates operation 200 to reestablish connections between worker nodes and a storage system. Operation 200 is an example operation for reestablishing iSCSI connections that use CHAP for authentication. In operation 200, each of node servers 123-125 periodically monitors the status of the connections established with their respective worker nodes 103-105 (step 201). Multiple connections may be established between a single worker node and storage system 101. For example, different storage volumes may be on different storage servers 152. To access both of those storage volumes, a connection may be established to each of the different storage servers 152. Node servers 123-125 may maintain a record of what the connection statuses should be on their respective worker nodes 103-105. For example, a node server may use a table or other data structure to record when a connection is established and indicate the connection's status as being active in association with an identifier for that connection. While there may be other connection statuses (e.g., establishing, failed, failing, etc.), each node server may only maintain a record of whether the connection should have an active status (i.e., has been established by the node server and has not intentionally been taken down by the node server) because that is how the dynamic storage provisioner will determine whether the actual connection statuses of a node include the correct active sessions. If the status of a particular connection is shown in the record as being active, then a node server will know that the connection should be reestablished if the connection's status indicates the connection has failed or there is no record of the connection actually existing. A connection may fail due to network issues between endpoints, due to a storage volume moving to a different one of storage servers 152, due to a worker node restarting, or for some other reason a connection could not be maintained.

If none of node servers 123-125 identify a failed connection (step 202), node servers 123-125 continue their periodic monitoring by returning to step 201. If, however, a failed connection is identified (step 202), the one of node servers 123-125 on the affected worker node directs the worker node to attempt a reconnection (step 203). If the CHAP credentials previously used by the worker node to establish the connection are still valid (i.e., have not been rotated or otherwise changed), then the worker node's attempt to reestablish the connection will be accepted (step 204). The worker node will, therefore, reestablish the connection with storage system 101 (step 205).

If the CHAP credentials are not accepted causing the CHAP authentication to fail (step 204), the one of node servers 123-125 at the worker node requests updated credentials from Trident controller 122 on controller node 102 (step 206). Controller node 102 at least hosts controller 122, which controls node servers 123-125 to mount storage volumes of storage system 101 at worker nodes 103-105. Controller node 102 may execute other processes in addition to controller 122 but only controller 122 is shown for this example. When user 141 rotates (i.e., updates or changes) the CHAP credentials at storage system 101 for accepting connection requests, user 141 also updates controller 122. User 141 does not update each of worker nodes 103-105 individually, which may be a tedious process since worker nodes come and go depending on the processing requirements of the cluster. As such, controller 122 will have the updated CHAP credentials when the worker node requests them at step 206.

When the worker node receives the new credentials, the worker node can reestablish the connection using those new credentials (step 205). In accordance with operation 200, the connection is reestablished whether the old credentials still work or new credentials are needed. Previously, the failed reestablishment of the connection may require manual intervention by a user to accomplish. Waiting for user intervention may result in a large amount of downtime for the worker node and the pod(s) executing thereon.

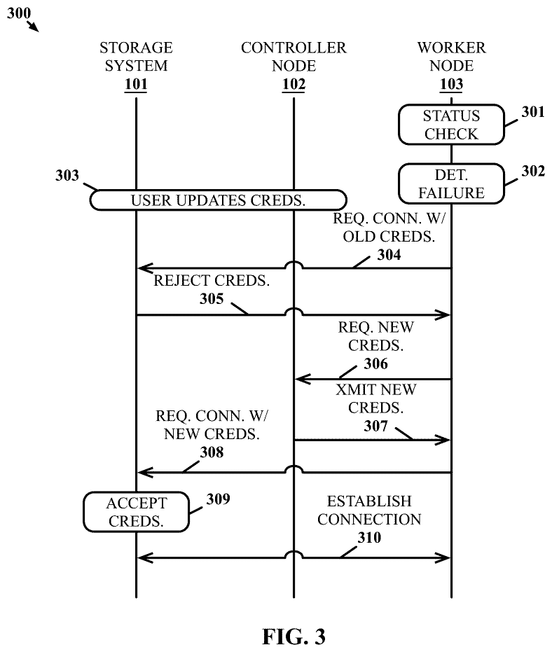

FIG. 3 illustrates operational scenario 300 for reestablishing connections between worker nodes and a storage system. Operational scenario 300 is another example of reestablishing an iSCSI connection. Operational scenario 300 is described with respect to worker node 103 but others of worker nodes 103-105 perform similarly to handle failed connections. Likewise, while operational scenario 300 only describes a single failed connection, multiple connections may fail and be reestablished using similar steps.

In operational scenario 300, node server 123 performs a status check on its connections with storage system 101 (step 301). The status check may be performed periodically (e.g., every 10 seconds) or node server 123 may continually monitor the status of its connections. Since node server 123 knows which connections should be operational due to node server 123 handling the establishment of the connections, node server 123 is able to recognize when one has failed (i.e., is no longer connected). Node server 123 may be in communication with pod 133 to determine which connections pod 133 requires to operate and those connections may be what node server 123 determines should be connected when performing a status check. In this example, node server 123 determines that a failure occurred on one of the connections (step 302). For instance, node server 123 may check the status of the connection, which node server 123 expects to be operational, only to find the connection is not connected.

At some point after the connection was last established, user 141 updates the CHAP credentials needed for storage system 101 to accept a connection request (step 303). The CHAP credentials are rotated at both storage system 101 and controller 122 of controller node 102. Since changes in CHAP credentials do not affect already established connections, the changes do not cause established connections to disconnect. As such, when worker node 103 requests a connection using previous CHAP credentials (step 304), storage system 101 rejects the credentials and does not allow establishment of the connection to reestablish the failed connection (step 305). The CHAP credentials may be transmitted by worker node 103 in response to a challenge received from storage system 101 in response to worker node 101 requesting the connection be reestablished.

Node server 123 is configured to request new credentials from controller 122 when node server 123's current credentials are rejected (step 306). In response to the request, controller 122 provides the new credentials (step 307). Now having the new credentials, worker node 103 requests the new connection again using the new credentials in place of the old credentials used previously (step 308). Since the new credentials match what is currently maintained at storage system 101 after the user update, storage system 101 accepts the credentials of worker node 103 (step 309). Upon accepting the credentials, storage system 101 proceeds with establishing the requested connection with worker node 103 (step 310).

In some examples, controller node 102 may push the new credentials to worker node 103 upon receiving the new credentials. In those examples, node server 123 may continue to use the credentials originally used to establish the connection during attempts to reestablish the connection. For instance, the connection protocol may specify that the credentials used to establish a connection also be used when reestablishing the connection. Once the protocol's reestablishment attempts have ended, node server 123 may be configured to start using the new credentials to attempt reestablishment of the connection (e.g., steps 308-310).

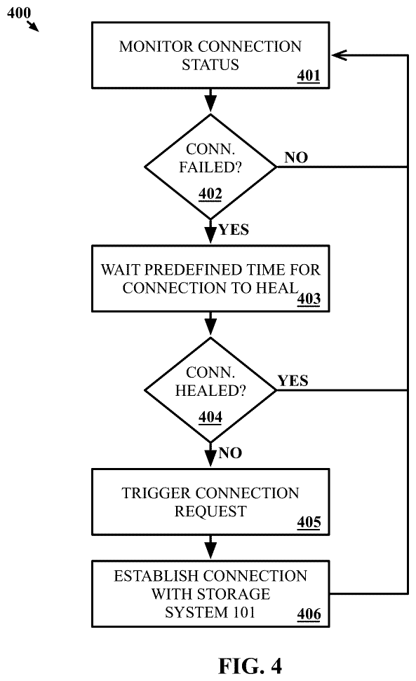

FIG. 4 illustrates operation 400 for reestablishing connections between worker nodes and a storage system. In operation 400, worker nodes 103-105 monitor connection status of connections with storage system 101 (step 401). Much like in operation 200, if all connections have a status that is expected by worker nodes 103-105 (step 402), then worker nodes 103-105 continue to monitor (e.g., periodically, on a set schedule, on a dynamically triggered schedule, etc.) the connections for failures. If a connection is determined to have failed (step 402), the node of worker nodes 103-105 having the failed connection waits a amount of time (e.g., a predefined amount of time) for the connection to heal (step 403). The amount of time may be defined or set by the protocol used for the connection. For example, NVMe may continue to attempt reconnection on its own for ten minutes. Therefore, the amount of time may be at least ten minutes. In some examples, where different protocols are being used for the connections (e.g., iSCSI and NVMe), the amount of time used for each protocol may differ so that both an NVMe and an iSCSI connection do not reestablish at the same time, which could result in a node lock. A node lock is a mechanism that prevents multiple hosts from accessing the same storage volume simultaneously. This is done to avoid data corruption and ensure data consistency. If the same amount of time was used for both protocols, the likelihood increases that reestablishment of a connection in one protocol to a storage volume will conflict (i.e., encounter a lock) with reestablishment of a connection in the other protocol to the same storage volume.

After waiting the amount of time, the worker node determines whether the connection healed itself during the interval (step 404). The worker node may perform another status check on the connection to determine whether it has a connected status. If the connection has reestablished already, the worker node can return to monitoring connection status at step 401. If the connection has not reestablished, then the node server on the worker node triggers a connection request by the worker node to reestablish the connection with storage system 101 (step 405). In this example, storage system 101 allows the request and establishes the connection (step 406). In other examples, the worker node may have to update credentials (e.g., CHAP credentials per the examples above) before storage system 101 will allow the connection. In those examples, the reason the connection was unable to heal during the wait time may be due to outdated credentials. In some cases, the worker node's failed attempts to reestablish the connection during the wait time due to invalid credentials may be enough to trigger the worker node to request new credentials. In those instances, the worker node may determine that the rejection of credentials during a challenge from storage system 101 indicates the credentials are invalid.

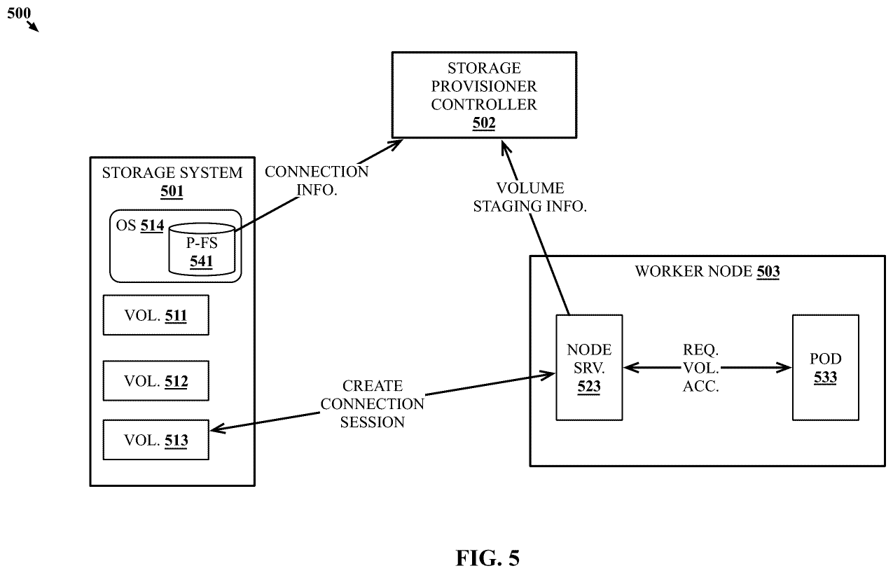

FIG. 5 illustrates implementation 500 for reestablishing connections between worker nodes and a storage system. Implementation 500 includes storage system 501, storage provisioner controller 502, and worker node 503. Worker node 503 is an example worker node that may be executing on computing servers 151 from implementation 100. Although not shown, additional worker nodes may exist in a cluster of worker nodes including worker node 503. Storage system 501 is an example of storage system 101 from implementation 100 above. Storage provisioner controller 502 is an example controller of a dynamic storage provisioner and may be executing on what implementation 100 refers to as controller node 102. While referred to herein as a controller node, storage provisioner controller 502 may be executing on a worker node, including worker node 503.

Worker node 503 includes node server 523. Other worker nodes in worker node 503's cluster execute node servers as well. Node server 523 orchestrates communication processes executing on worker node 503 and various components within the storage infrastructure of storage system 501. In this example, pod 533 is a process accesses storage system 501 using node server 523 but other types of workloads may use node server 523 to access storage system 501. Node server 523 interprets and processes incoming requests from pod 533 (and other pods/workloads that may be executing on worker node 503), orchestrating the allocation, modification, or deletion of storage volumes as needed. Storage provisioner controller 502 orchestrates interactions with node servers, including node server 523, deployed on worker nodes, including worker node 503, in the cluster. Storage provisioner controller 502 communicates with these worker nodes to coordinate provisioning tasks, optimize resource utilization, and ensure seamless integration with the underlying infrastructure. Storage provisioner controller 502 may dynamically allocate storage resources, monitor performance metrics, and/or adapt configurations to meet dynamic workload demands.

In this example, storage provisioner controller 502 further gathers information on the status of connections between worker nodes and storage system 501. Protocols like iSCSI and NVMe that enable storage volume access over TCP connections will often include procedures to handle reestablishing connections that fail. Those procedures do not always recognize certain failure conditions. For instance, storage system 501 includes three storage volumes 511-513 (or other type of logical storage unit to which a connection can be made) but any number of storage volumes may exist. Storage system 501 may be distributed across multiple storage components (e.g., storage servers/nodes). When a storage volume is moved from one storage component to another, a connection for that storage volume may remain connected at the previous storage component. To iSCSI or NVMe, the connection may appear fine and have no reason to be reestablished. However, storage provisioner controller 502 can help determine the connection has “failed” in that it can no longer provide access to the desired storage volume. Likewise, even in connection failure situations that the protocol can identify, the protocol may timeout when trying to reconnect, which allows a desired connection to remain in a failed state. Using the dynamic storage provisioner's resources to identify those connection issues, enables the components of the dynamic storage provisioner (e.g., storage provisioner controller 502 and node server 523) to take over where the protocol left off to reestablish the connection.

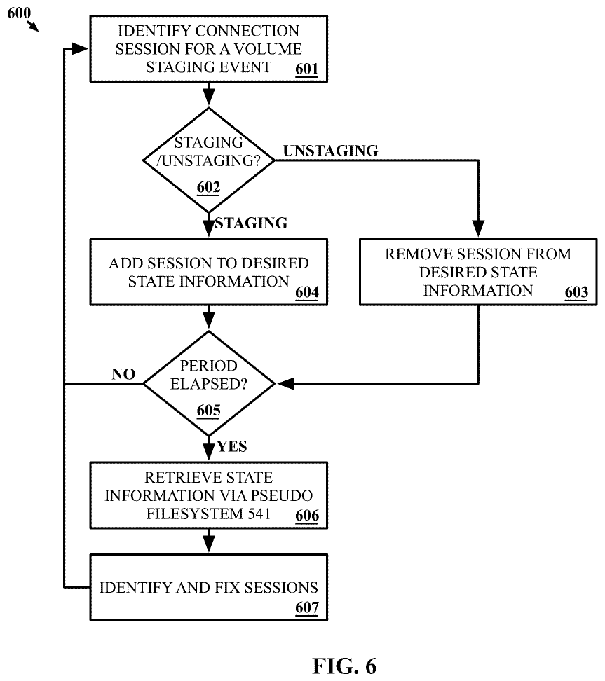

FIG. 6 illustrates operation 600 to reestablish connections between worker nodes and a storage system. In operation 600, storage provisioner controller 502 determines a desired state of connection sessions. A desired state refers to the connection sessions in which the dynamic storage provisioner established between worker nodes and storage volumes 511-513. A connection session may represent a single connection or may include multiple connections. A connection session may provide information identifying the connection, such as connection endpoints (e.g., identified by an identifier, such as an iSCSI qualified name), storage volume identifier (e.g., a logical unit number), authentication information (e.g., CHAP information used to establish the connection), or some other type of information that may be useful for identifying a connection and/or the connection's status—including combinations thereof.

To track the desired state, storage provisioner controller 502 monitors volume staging events from worker nodes (step 601). A volume staging event may include a node server performing a staging operation to mount (i.e., create a connection to) one of storage volumes 511-513 for access by a workload executing thereon or an unstaging operation to remove an already mounted storage volume. Node servers on the worker nodes will notify storage provisioner controller 502 about a volume to be mounted/unmounted, notifying storage provisioner controller 502 about the connection sessions being established and taken down. As a controller for the node servers, storage provisioner controller 502 may also provide direction to the node servers (e.g., confirming they are allowed to mount requested volumes).

If storage provisioner controller 502 detects an unstaging operation (step 602), storage provisioner controller 502 removes the session associated with the unstaging operation from desired state information maintained by storage provisioner controller 502 (step 603). Presumably, the session was included in the desired state information (e.g., due to being added to the desired state information upon establishment or during a poll of node servers for information about their connection sessions) but, if the connection session is somehow absent from the desired state information, storage provisioner controller 502 may simply allow it to remain that way since the connection session is being ended anyway. In contrast, if storage provisioner controller 502 detects a staging operation (step 602), storage provisioner controller 502 adds session information about the connection created during the staging operation to the desired state information (step 604). For example, node server 523 may stage storage volume 513 and storage provisioner controller 502 may record information about a connection session established when node server 523 mounts storage volume 513 for use by pod 533.

Storage provisioner controller 502 is configured to determine (e.g., periodically, on a set schedule, in response to a triggering event, etc.) whether connection sessions are in need of repair (e.g., reconnection). For example, storage provisioner controller 502 may be configured to determine whether any connection sessions need fixing every five minutes. The period may be defined as an amount time greater than or equal to an amount of time in which a connection protocol will attempt to fix connection issues itself. This allows the protocol time to handle connection issues prior to storage provisioner controller 502 stepping in. As such, storage provisioner controller 502 determines whether a period has elapsed since storage provisioner controller 502 last determined whether connections are in need of repair (step 605). If the period has not elapsed, storage provisioner controller 502 continues to monitor for staging events to keep the desired state information up to date.

If the period has elapsed, storage provisioner controller 502 retrieves state information via pseudo filesystem 541 (step 606). Pseudo filesystem 541 is a utility provided by operating system 514. The Linux kernel include includes a pseudo filesystem utility called sysfs but other operating systems my include different utilities. Pseudo filesystem 541 provides a structured interface for accessing kernel data structures and system information. Through pseudo filesystem 541, kernel objects and device attributes are represented as hierarchical directories and files, facilitating easy navigation and manipulation by user space applications. This utility dynamically populates the filesystem with information about various system components, including devices, buses, drivers, and, at least in operation 600, connection session information, allowing for real-time monitoring and configuration. Storage provisioner controller 502 interacts with pseudo filesystem 541 to retrieve detailed information about connection sessions currently connected to storage system 501. In other examples, storage provisioner controller 502 may interact with pseudo filesystems at the worker nodes to retrieve connection session information from worker nodes rather than, or in addition to, storage system 501. Alternative mechanisms for determining actual connection state may also be used.

Using the desired state information and the connection state information retrieved from pseudo filesystem 541, storage provisioner controller 502 identifies connection sessions that require fixing and fixes, or at least attempts to fix those sessions (step 607). Operation 700 and operation 800 described below are examples of how storage provisioner controller 502 may perform step 607, although, other mechanisms may be used.

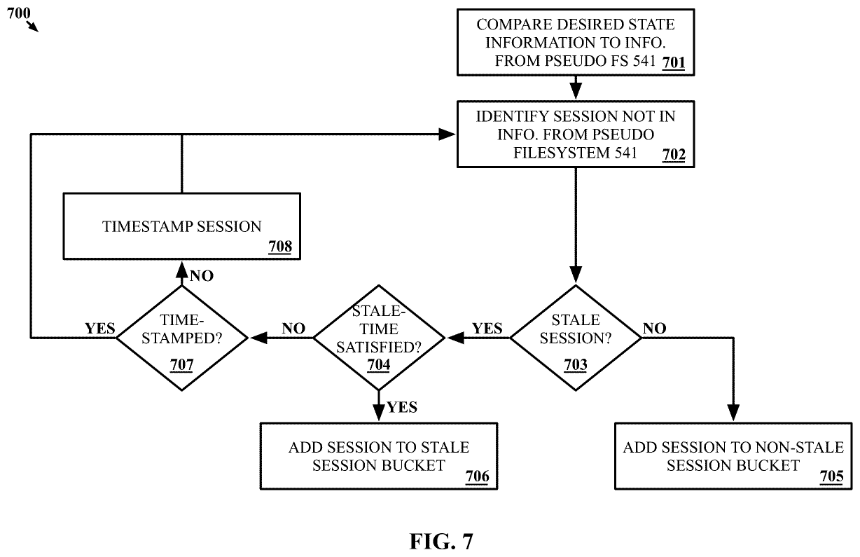

FIG. 7 illustrates operation 700 to reestablish connections between worker nodes and a storage system. In operation 700, storage provisioner controller 502 compares the desired state information determined in operation 600 to the connection state information determined from pseudo filesystem 541 (step 701). While some information about individual sessions in each set of state information may differ, the two sets of state information provide enough detail to determine whether a session referred to in one set of state information is the same as a session in the other set of state information. For example, the session may be identified by both sets having the same unique session identifier, by endpoints being the same for a connection in both sets, or some other manner of determining a session is the same between the desired state information and the connection state information.

From the comparison, storage provisioner controller 502 identifies a session specified in the desired state information that is not included as expected in the connection state information received from pseudo filesystem 541 (step 702). The session may not be included in its entirety within the connection state information (i.e., an entry for the session exists in the desired state information but not in the connection state information) or may not have the same status within the connection state information (e.g., the entry in the desired state information may specify a particular storage volume the session's connection accesses but the connection state information may not indicate that particular volume). Storage provisioner controller 502 determines whether the identified session is a stale session or a non-stale session (step 703). A stale session is a session that failed but could not be reestablished because authentication credentials changed since the previous time in which the session was established. For instance, node server 523 may have established a connection session to access storage volume 513 using a first set of CHAP credentials that were rotated by a user to a second set of CHAP credentials. Should the session fail, if node server 523 was not provided with the second set of CHAP credentials, storage system 501 will deny node server 523's attempt to reestablish the session connection with storage volume 513. That session connection is a stale session. Other types of identified connection sessions are considered non-stale and are added to a non-stale bucket (i.e., grouping) of sessions (step 705).

For a stale session, storage provisioner controller 502 determines whether the session has been stale for a predefined amount of time (step 704). The amount of time may be defined to be greater than or equal to an amount of time in which a reply from the target may be received over the session connection. This enables storage provisioner controller 502 to ensure the session is indeed stale. The session may be timestamped from when storage provisioner controller 502 first identified the session as being stale. The amount of time from the time indicated by the timestamp is compared to the predefined amount of time and, if the session has been stale for equal to or longer than the predefined amount of time, storage provisioner controller 502 places the session in a stale session bucket (step 706).

A session that is not timestamped is considered to not meet the predefined amount of time threshold so storage provisioner controller 502 next determines whether the session is timestamped (step 707). If the session is timestamped, storage provisioner controller 502 returns to step 702 to process another session (should there be one) that is not featured in the connection state information as expected based on the desired state information. If, however, the session is not timestamped, storage provisioner controller 502 adds a timestamp indicating the current time as being when the session was first determined to be stale (step 708). Storage provisioner controller 502 may store the timestamp in the session's entry within the desired state information or may store the timestamp elsewhere. Storage provisioner controller 502 then returns to step 702 to process any additional sessions. It should be understood that the sessions may be processed in parallel instead of series as implied by the flow of operation 700.

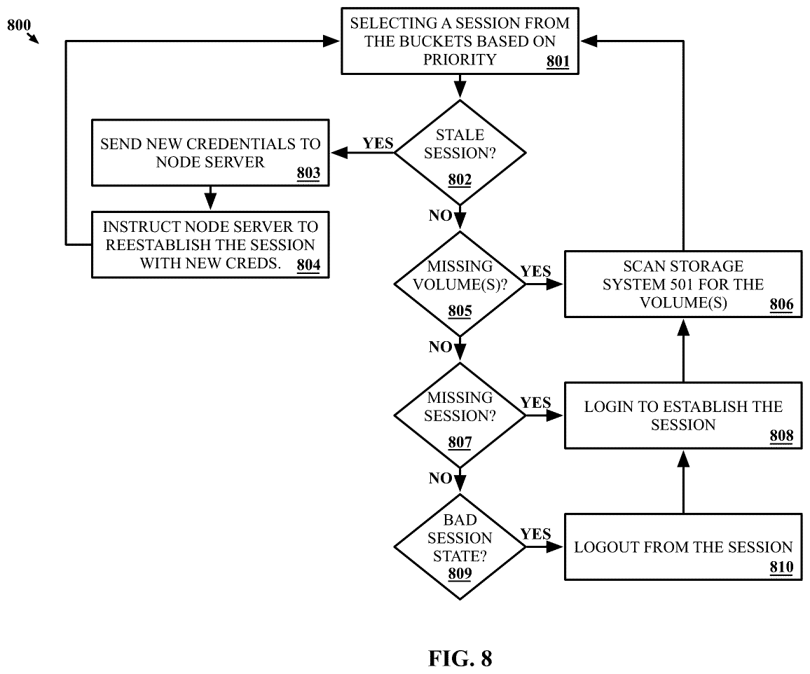

FIG. 8 illustrates operation 800 to reestablish connections between worker nodes and a storage system. Operation 800 processes the sessions from the buckets in an attempt to fix the sessions and get the sessions back to an expected state indicated in the desired state information. In operation 800, storage provisioner controller 502 selects a state from one of the buckets (step 801). The session may be selected arbitrarily or based on priority. For example, stale sessions may be prioritized for repair before non-stale sessions and, therefore, storage provisioner controller 502 may attempt to fix all stale sessions in the stale session bucket prior to attempting to fix a session from the non-stale bucket. Since the stale sessions may be timestamped, storage provisioner controller 502 may also prioritize selection of older stale sessions over newer stale sessions.

If a stale session was selected by storage provisioner controller 502 (step 802), storage provisioner controller 502 sends new authentication credentials to the node server (step 803). In this example, connection sessions between node server 523 and storage system 501 will be used as examples. For instance, a stale session between worker node 503 and storage system 501, then storage provisioner controller 502 sends updated authentication credentials to node server 523. The credentials may have been updated, or rotated, at the instruction of a user. Node server 523 may not have the updated credentials because the user only informed storage system 501 and storage provisioner controller 502 of the updated credentials. The user may know that they can rely on storage provisioner controller 502 to distribute the credentials as needed to the node servers, as storage provisioner controller 502 does at step 803. In some examples, node server 523 may automatically attempt to reestablish the stale connection using the new credentials received from storage provisioner controller 502 or storage provisioner controller 502 may explicitly instruct node server 523 to reestablish the connection session (step 804).

If a non-stale session was selected by storage provisioner controller 502 (step 802), storage provisioner controller 502 determines an issue with the non-stale session causing the non-stale session to have been identified for repair (steps 805, 807, 809). The issues may be indicated by the differences between the desired session state indicated by the desired state information and the actual session state indicated by the connection state information received from pseudo filesystem 541. Three possible issues are set forth in this example, but other issues may also be indicated by the differences in node state.

In operation 800, storage provisioner controller 502 determines whether one or more of the volumes to which the connection session is supposed to be connected, as indicated by the desired state information, are missing (i.e., is not indicated in the connection state information) (step 805). A volume may be missing because it was moved elsewhere in storage system 501 (e.g., so maintenance can be performed on a component of storage system 501). In response to determining a volume is missing, storage provisioner controller 502 scans storage system 501 for the missing volume(s) and redirects the session to the new location (step 806).

If storage provisioner controller 502 determines a session is missing altogether (i.e., the session has an entry in the desired state information but no entry in the connection state information) (step 807), storage provisioner controller 502 directs node server 523 login to a new session (step 808). Storage provisioner controller 502 may provide node server 523 with new authentication credentials for the login if node server 523 does not have updated credentials. Storage provisioner controller 502 further scans storage system 501 for one or more storage volumes in storage system 501 to which the desired state information indicates the session should be connected (step 806).

If storage provisioner controller 502 determines session exists but is in a bad state (step 809), storage provisioner controller 502 directs node server 523 to log out from the session to end the session (step 810). A bad state may be any state in which the session cannot perform as intended. Logging out of the session to end the session enables the session to be recreated in accordance with the state indicated by the desired state information. As such, storage provisioner controller 502 instructs node server 523 to log into a new session (step 808) and scans for volume(s) in storage system 501 to which the desired state information indicates the new session should be connected (and to which the old session should have been connected).

In any of the situations above, once storage provisioner controller 502 has fixed the selected session, storage provisioner controller 502 returns to step 801 to select another session from the buckets for fixing unless both buckets are empty of sessions (i.e., storage provisioner controller 502 has already attempted to fix all sessions). Storage provisioner controller 502 may fail in its attempt to fix a session because there may be factors preventing the session from being fixed. For example, a network error may persist that prevents worker node 503 from communicating with storage system 501. In such situations, a timeout period may be employed that indicates to storage provisioner controller 502 that the connection could not be reestablished. For instance, storage provisioner controller 502 may be configured to try reconnecting a session for 60 seconds before giving up. Storage provisioner controller 502 may be configured to notify a user when a session cannot be fixed within the timeout period. In some examples, another worker node may request a node level lock on storage volume preventing node server 523 from also connecting to that volume. Storage provisioner controller 502 will, therefore, return to step 801 since the session cannot be fixed during the node lock.

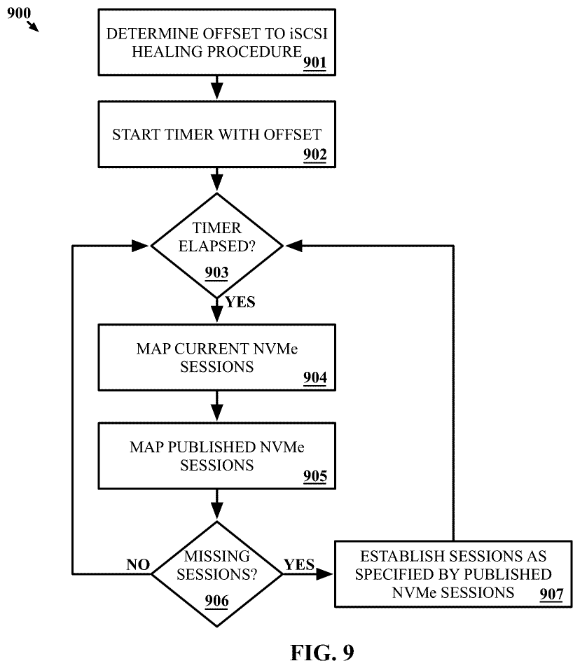

FIG. 9 illustrates operation 900 to reestablish connections between worker nodes and a storage system. Operation 900 is an example of how connection session repair may be handled when multiple protocols are used for connections handled by the dynamic storage provisioner. Specifically, NVMe and iSCSI are both used for connections to storage volumes over TCP. Storage provisioner controller 502 is configured with healing procedures to fix both types of connections. As explained in operation 600, a healing procedure may be performed periodically. If the periods for both protocols' healing procedures align, healing an NVMe connection may prevent an iSCSI connection from healing or vice versa. Therefore, storage provisioner controller 502 determines an offset for the period to perform the NVMe healing procedure relative to the period for when the iSCSI healing procedure is performed (step 901). The offset may be manually entered by a user or storage provisioner controller 502 may automatically determine the offset based on the healing period for iSCSI. For example, the period for healing iSCSI may be five minutes. Storage provisioner controller 502 may determine the period for NVMe healing should be the same to ensure the two healing processes will not align at any point. Moreover, storage provisioner controller 502 may determine the offset should be long enough to ensure the iSCSI healing procedure has completed prior to beginning the NVMe healing procedure. Storage provisioner controller 502 may likewise determine the offset such that the NVMe healing procedure can complete prior to the next period of the iSCSI healing procedure.

After determining the offset, storage provisioner controller 502 starts a timer with the offset to the iSCSI healing procedure (step 902). The timer may remain fully independent of the iSCSI period timer or may be tied to the iSCSI period timer. For example, storage provisioner controller 502 may determine both periods should be five minutes and the offset for the NVMe period should be two and a half minutes. Storage provisioner controller 502 may wait two and a half minutes after the iSCSI timer elapses before starting the NVMe five-minute timer or storage provisioner controller 502 may start a two and a half minute timer whenever the iSCSI timer starts, which ensures the timers will always be in sync.

Storage provisioner controller 502 waits for the NVMe timer to elapse before starting the NVMe healing process (step 903). Upon the timer elapse, storage provisioner controller 502 begins the healing process. In this case, storage provisioner controller 502 maps current NVMe sessions (step 904) and published NVMe sessions (step 905). That is, for each of the current NVMe sessions, storage provisioner controller 502 determines whether a corresponding NVMe session is listed in (i.e., maps to) the published NVMe sessions. For example, an NVMe session may be listed in the current NVMe sessions with an identifier that uniquely identifies the session relative to other NVMe sessions. Storage provisioner controller 502 may determine whether the identifier is also listed in the published NVMe sessions. A mapping, therefore, may include a listing of identifiers that are included in both the current NVMe sessions and the published NVMe sessions. Storage provisioner controller 502 may perform the mappings each period or may continually perform the mappings to have up-to-date information when the period does expire. Similar to the desired state information above, storage provisioner controller 502 may monitor requests to establish and end NVMe sessions from worker nodes to determine which NVMe sessions should be included in the mapping of the published NVMe sessions. The mapping of the current sessions may be determined from queries to storage system 501 (e.g., using pseudo filesystem 541 or other mechanism) and/or node servers like node server 523.

Storage provisioner controller 502 determines whether any sessions are included in one mapping but not the other (step 906). If the NVMe sessions in both mappings agree, storage provisioner controller 502 returns to step 903 to wait for the timer to elapse for the next period. If storage provisioner controller 502 determines that one or more sessions do not match between the mappings, storage provisioner controller 502 directs node servers at the worker nodes to establish sessions in accordance the sessions included in the published sessions, which show the desired state of the NVMe sessions (step 907). For instance, if the published session mapping indicates an NVMe session between node server 523 and storage volume 513 but no such session exists according to the current session mapping, storage provisioner controller 502 directs node server 523 to create the session to storage volume 513. In some examples, a session in the current session mapping may not exist in the published session mapping. In those cases, storage provisioner controller 502 may not take any action since it is possible that a NVMe session namespace exists outside of the dynamic storage provisioner. Once storage provisioner controller 502 has completed fixing the identified sessions from the mapping comparison, storage provisioner controller 502 returns to step 903 to await the timer elapsing for the next period.

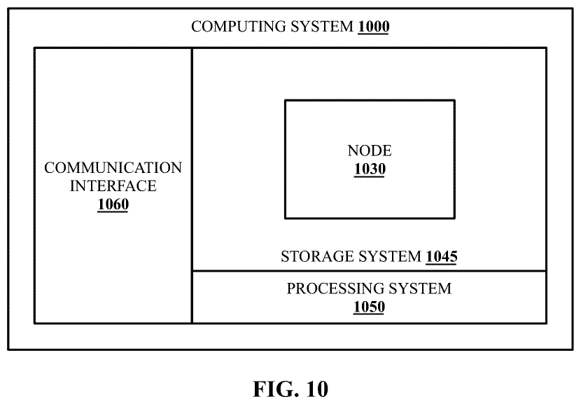

FIG. 10 illustrates a computing system 1000 for reestablishing connections between worker nodes and a storage system. Computing system 1000 is representative of any computing system or systems with which the various operational architectures, processes, scenarios, and sequences disclosed herein can be implemented. Computing system 1000 is an example architecture for computing servers 151 and storage servers 152, although other examples may exist. Computing system 1000 includes storage system 1045, processing system 1050, and communication interface 1060. Processing system 1050 is operatively linked to communication interface 1060 and storage system 1045. Communication interface 1060 may be communicatively linked to storage system 1045 in some implementations. Computing system 1000 may further include other components such as a battery and enclosure that are not shown for clarity.

Communication interface 1060 comprises components that communicate over communication links, such as network cards, ports, radio frequency (RF), processing circuitry and software, or some other communication devices. Communication interface 1060 may be configured to communicate over metallic, wireless, or optical links. Communication interface 1060 may be configured to use Time Division Multiplex (TDM), Internet Protocol (IP), Ethernet, optical networking, wireless protocols, communication signaling, or some other communication format—including combinations thereof. Communication interface 1060 may be configured to communicate with other computing systems via one or more networks.

Processing system 1050 comprises microprocessor and other circuitry that retrieves and executes operating software from storage system 1045. Storage system 1045 may include volatile and nonvolatile, removable, and non-removable media implemented in any method or technology for storage of information, such as computer readable instructions, data structures, program modules, or other data. Storage system 1045 may be implemented as a single storage device but may also be implemented across multiple storage devices or sub-systems. Storage system 1045 may comprise additional elements, such as a controller to read operating software from the storage systems. Examples of storage media include random access memory, read only memory, magnetic disks, optical disks, and flash memory, as well as any combination or variation thereof, or any other type of storage media. In some implementations, the storage media may be a non-transitory storage media. In some instances, at least a portion of the storage media may be transitory. In no interpretations would storage media of storage system 1045, or any other computer-readable storage medium herein, be considered a transitory form of signal transmission (often referred to as “signals per se”), such as a propagating electrical or electromagnetic signal or carrier wave.

Processing system 1050 is typically mounted on a circuit board that may also hold the storage system. The operating software of storage system 1045 comprises computer programs, firmware, or some other form of machine-readable program instructions. The operating software of storage system 1045 comprises node module 1030. The operating software on storage system 1045 may further include an operating system, utilities, drivers, network interfaces, applications, or some other type of software. When read and executed by processing system 1050 the operating software on storage system 1045 directs computing system 1000 to network routing advertisements as described herein. Node module 1030 may execute natively on processing system 1050 or the operating software may include virtualization software, such as a hypervisor, to virtualize computing hardware on which node module 1030 executes.

In at least one example, node module 1030 executes on processing system 1050 and directs processing system 1050 to establish TCP-based connections with a storage system and periodically determine status of the TCP-based connections. When the status indicates a first connection of the TCP-based connections has failed, node module 1030 directs processing system 1050 to determine credentials used to establish the first connection are invalid and, in response to determining the credentials are invalid, request new credentials from a controller node. Node module 1030 then directs processing system 1050 to reestablish the first connection using the new credentials.

The included descriptions and figures depict specific implementations to teach those skilled in the art how to make and use the best mode. For teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

What is claimed is:

1. A method for reestablishing TCP-based connections when authentication credentials update, the method comprising:
establishing a plurality of TCP-based connections between a plurality of worker nodes and a storage system to enable the plurality of worker nodes to access storage volumes in the storage system;
when a status of a first connection of the plurality of TCP-based connections indicates the first connection failed between a worker node of the plurality of worker nodes and the storage system, waiting an amount of time;
upon the amount of time elapsing, determining the first connection has not recovered;
in response to determining the first connection has not recovered, determining credentials used by the worker node to establish the first connection are currently invalid;
in response to determining the credentials are currently invalid, requesting new credentials from a controller node; and
reestablishing the first connection using the new credentials.

2. The method of claim 1, wherein determining the credentials are invalid comprises:
during the amount of time, transmitting a request for reestablishment of the first connection from the worker node to the storage system;
upon the worker node receiving a challenge, transmitting the credentials from the worker node to the storage system as a response to the challenge;
at the worker node, receiving a rejection of the credentials from the storage system; and
after the amount of time, identifying the rejection that occurred during the amount of time.

3. The method of claim 1, comprising:
receiving the new credentials in the controller node after establishing the first connection and before the first connection failed;
instruct the plurality of worker nodes to use the new credentials for establishing subsequent TCP-based connections; and
directing the worker node to use the new credentials in response to the worker node requesting the new credentials.

4. The method of claim 1, wherein the amount of time is greater than or equal to a period during which a protocol used for the plurality of TCP-based connections will attempt to reconnect the first connection.

5. The method of claim 4, wherein the protocol is one of two different TCP-based protocols used for the plurality of TCP-based connections, the method comprising:
determining the first connection uses a first protocol of the two different TCP-based protocols;
identifying a first wait time of the first protocol and a second wait time of a second protocol of the two different TCP-based protocols, wherein the first wait time is the amount of time; and
waiting an offset time relative to the second wait time before waiting the amount of time.

6. The method of claim 1, wherein determining the status of the plurality of TCP-based connections comprises:
accessing a pseudo file system provided by an operating system of the storage system, wherein the pseudo file system identifies connections to the storage system; and
determining that the first connection is absent from the connections to the storage system.

7. The method of claim 1, comprising:
requesting connection information from the storage system, wherein the connection information identifies establishment credentials used to establish connections to the storage system; and
determining from the establishment credentials that the credentials are invalid.

8. The method of claim 1, wherein the first connection connects a worker node of the plurality of worker nodes to a first logical storage unit of the storage system and wherein the status indicates a second connection of the TCP-based connections remains connected to the worker node to connect the worker node to a second logical storage unit of the storage system.

9. The method of claim 1, wherein the first connection failed due to a logical storage unit in the storage system being missing and wherein reestablishing the first connection comprises:
scanning the storage system for a new location of the logical storage unit; and
requesting a new connection to the logical storage unit at the new location.

10. The method of claim 1, wherein the first connection is included in a missing connection session with the storage system and wherein reestablishing the first connection comprises:
logging into the storage system to create a new connection session; and
requesting a new connection in the new connection session.

11. The method of claim 1, wherein the first connection is included in a failed connection session with the storage system and wherein the reestablishing the first connection comprises:
logging out from the failed connection session;
logging into a new connection session with the storage system; and
requesting a new connection in the new connection session.

12. A method for reestablishing failed iSCSI (Internet Small Computer System Interface) connections after authentication credentials update, the method comprising:
capturing state information about iSCSI sessions of a worker node, wherein the state information includes a desired state of the iSCSI sessions and an actual state of the iSCSI sessions;
identifying differences between the desired state and the actual state, wherein the differences indicate at least one iSCSI session is no longer working as indicated by the desired state; and
fixing the at least one iSCSI session to match a state of the at least one iSCSI session indicated by the desired state.

13. The method of claim 12, wherein capturing the state information comprises:
adding connections created during volume staging to the desired state; and
removing connections ended during volume unstaging from the desired state.

14. The method of claim 12, wherein identifying the differences comprises:
identifying one or more stale sessions; and
identifying one or more non-stale sessions, wherein a non-stale session comprises one of the iSCSI sessions that is not logged in or missing a corresponding storage volume.

15. The method of claim 14, wherein identifying the one or more stale sessions includes:
add a stale session to the one or more stale sessions when the stale session is using authentication credentials that do not match current in user credentials and/or when a timestamp for the stale session indicates the stale session has been stale for a wait time.

16. The method of claim 14, wherein the at least one iSCSI session includes the one or more stale sessions and the one or more non-stale sessions and wherein fixing the at least one iSCSI session comprises:
fixing the at least one iSCSI session based on priority, wherein the stale sessions are prioritized over the non-stale sessions and older ones of the stale sessions are prioritized relative to newer ones of the stale sessions.

17. The method of claim 16, comprising:
stopping fixing one or more of the at least one iSCSI session associated with a storage volume in response to another worker node attempting to obtain a node-level lock on the storage volume.

18. A method for reestablishing failed NVMe (Non-Volatile Memory Express) sessions between worker nodes and a storage system, the method comprising:
creating a map of current NVMe sessions between the worker nodes and the storage system;
creating a map of published NVMe session between the worker nodes and the storage system;
determining a discrepancy where a NVMe session specified in the map of published NVMe sessions is not specified in the map of current NVMe sessions; and
in response to determining the discrepancy, establishing the NVMe session in accordance with specifications from the map of published NVMe sessions.

19. The method of claim 18, wherein the NVMe session is one of a pair of NVMe sessions between a worker node and the storage system for high availability and wherein establishing the NVMe session comprises:
waiting a period to allow NVMe time to reconnect the NVMe session; and
when the NVMe session is still not connected upon expiration of the period, reconnecting the NVMe session.

20. The method of claim 18, wherein iSCSI sessions also exist between the worker nodes and the storage system and the method comprising:
offsetting the establishing of the NVMe session relative to a procedure for reestablishing one or more of the iSCSI sessions to avoid potential node lock caused by the procedure.

21. A system that reestablishes TCP-based connections after authentication credentials update, the system comprising:
a computing cluster comprising a plurality of computing nodes;
a storage system storing a plurality of storage volumes;
a worker node of the plurality of computing nodes configured to:
use the authentication credentials to establish a connection with the storage system using a storage networking protocol to access a volume of the plurality of storage volumes;
detect the connection has failed;
wait for the storage networking protocol to attempt reestablishment of the connection using the authentication credentials;
after the storage networking protocol stops attempting the reestablishment, request new authentication credentials from a controller node of the plurality of computing nodes; and
reestablish the connection with the storage system using the new authentication credentials; and
the controller node configured to:
receive the new authentication credentials when the storage system receives the new authentication credentials; and
transmit the new authentication credentials to the worker node when the worker node requests the new authentication credentials.

22. The system of claim 21, comprising the worker node configured to:
in response to detecting the connection has failed, transmit a request for reestablishment of the connection to the storage system;
receive a challenge from the storage system in response to the request;
transmit the authentication credentials to the storage system as a response to the challenge; and
receive a rejection of the credentials from the storage system, wherein the new authentication credentials are requested after receiving the rejection.

23. The system of claim 21, wherein the worker node configured to detect the connection has failed comprises the worker node configured to:
indicating in a data structure a plurality of connections, including the connection, have been established;
determine a current connection state of the plurality of connections; and
determine the current connection state indicates the connection is not established while the data structure indicates the connection is established.

24. The system of claim 21, wherein the worker node configured to detect the connection has failed comprises the worker node configured to:
timestamp the connection in response to determining the connection is not currently connected, wherein the connection is marked as stale when the timestamp indicates the connection has not been connected for a threshold amount of time; and
request the new authentication credentials in response to the connection being marked as stale.

25. The system of claim 24, comprising the worker node configured to:
determining the authentication credentials are invalid prior to the threshold amount of time being reached for the connection; and
marking the connection as stale in response to the authentication credentials being invalid.
